(19) United States
(12) Patent Application Publication
(10) Pub. No.: US 2026/0336140 A1
(43) Pub. Date: Oct. 29, 2026

(54) SCRAPER

(71) Applicant: Maya Technologies Limited, Hong Kong (CN)

(72) Inventor: Shanglin Yang, Hong Kong (CN)

(21) Appl. No.: 19/732,677

(22) Filed: Jul. 7, 2026

Related U.S. Application Data
(63) Continuation-in-part of application No. 19/358,424, filed on Oct. 15, 2025, now Pat. No. 12,709,032.
Application No. 19/358,424 is a continuation of application No. 19/190,853, filed on Apr. 28, 2025, now Pat. No. 12,472,650.
Application No. 19/190,853 is a continuation-in-part of application No. 29/989,717, filed on Feb. 14, 2025, now Pat. No. D1096038.
Application No. 29/989,717 is a continuation-in-part of application No. 29/989,709, filed on Feb. 14, 2025, now Pat. No. D1126718.
(63) Continuation-in-part of application No. 19/719,203, filed on Jun. 25, 2026.
Application No. 19/719,203 is a continuation-in-part of application No. 19/358,424, filed on Oct. 15, 2025, now Pat. No. 12,709,032.

(30) Foreign Application Priority Data
Apr. 1, 2025 (CN) 202520601410.5
May 26, 2026 (CN) 202620759555.2
May 26, 2026 (CN) 202630263807.8

(51) Int. Cl. B26B 5/00; A47L 13/08

(52) U.S. Cl. CPC B26B 5/003; A47L 13/08

(57) ABSTRACT

A scraper includes a first base body and a second base body. The first base body has a first end and a second end. The first base body includes a limiting wall. The second base body includes a connection portion and a loading portion. The loading portion and the limiting wall cooperatively load a blade. At least one of the loading portion and the limiting wall is arranged with an engagement structure, mated with the blade to limit a position of the blade. The loading portion can slide to reach an in-use position and a replacement position. At the in-use position, a first distance is formed between the third end and the limiting wall. At the replacement position, a second distance is formed between the third end and the limiting wall, and the second distance is greater than the first distance.

### CROSS REFERENCE TO RELATED APPLICATIONS

This application is a continuation-in-part of: the U.S. patent application Ser. Nos. 19/358,424, filed on Oct. 15, 2025; and the 19/719,203, filed on Jun. 25, 2026. The U.S. patent application Ser. No. 19/358,424 is a continuation application of the U.S. patent application Ser. No. 19/190,853, filed on Apr. 28, 2025, which is issued with the U.S. Pat. No. 12,472,650. The U.S. patent application Ser. No. 19/190,853 is a continuation-in-part of: the U.S. design application Ser. No. 29/989,717, filed on Feb. 14, 2025, which is issued with design No. D1,096,038; and the U.S. design application Ser. No. 29/989,709, filed on Feb. 14, 2025. The U.S. patent application Ser. No. 19/719,203 claims priorities of: the Chinese patent application No. 202520601410.5, filed on Apr. 1, 2025; the Chinese patent application Nos. 202620759555.2, filed on May 26, 2026; and 202630263807.8, filed on May 26, 2026. The U.S. patent application Ser. No. 19/719,203 is a continuation-in-part of the U.S. patent application Ser. No. 19/358,424, filed on Oct. 15, 2025. The U.S. patent application Ser. No. 19/358,424 is a continuation application of the U.S. patent application Ser. No. 19/190,853, filed on Apr. 28, 2025, which is issued with the U.S. Pat. No. 12,472,650. The disclosure of the aforementioned application is incorporated by reference herein in its entirety.

### FIELD OF THE DISCLOSURE

The present disclosure relates to the field of cutting tool, and particularly to a scraper.

### BACKGROUND

A scraper may be arranged with a single blade clamp structure to clamp a blade. Therefore, the scraper may not be adaptively applicable for a blade with cladding, a blade without cladding, a blade without any hole, or a blade with notches at various positions. When a user replaces blades of various types, the blade may not be inserted easily, or may not be positioned stably, or may be inconveniently removed. Therefore, the scraper may have poor adaptability, and user experience may be affected.

### SUMMARY

The following presents a simplified summary of the disclosure in order to provide a basic understanding of some aspects of the disclosure. This summary is not an extensive overview of the disclosure. It is not intended to identify critical elements or to delineate the scope of the disclosure. Its sole purpose is to present some concepts of the disclosure in a simplified form as a prelude to the more detailed description that is presented elsewhere.

In some embodiments, a scraper may include a first base body and a second base body. The first base body may have a first end and a second end away from the first end. The first base body may include a limiting wall disposed at or near the first end. The second base body may include a connection portion and a loading portion, the connection portion is slidably connected with the first base body. The loading portion and the limiting wall are configured to cooperatively load a blade. The loading portion may have a third end away from the connection portion and a fourth end near the connection portion. At least one of the loading portion and the limiting wall is arranged with an engagement structure; the engagement structure is capable of being mated with the blade to limit a relative position of the blade with respect to the loading portion and/or the limiting wall. As the second base body slides, the loading portion is capable of reaching an in-use position and a replacement position. When the loading portion is at the in-use position, a first distance is formed between the third end and the limiting wall in a thickness direction of the scraper. When the loading portion is at the replacement position, a second distance is formed between the third end and the limiting wall in the thickness direction of the scraper, and the second distance is greater than the first distance.

In some embodiments, a scraper may include: a first base body, a second base body, and a limiting wall. The first base body may have a first end and a second end away from the first end. The second base body may include a connection portion and a loading portion, the connection portion is slidably connected with the first base body, the loading portion has a third end away from the connection portion and a fourth end near the connection portion. The limiting wall may have a connection end and a free end away from the connection end. The connection end is connected to the second base body; and the loading portion and the limiting wall are configured to cooperatively load a blade. At least one of the loading portion and the limiting wall is arranged with an engagement structure; the engagement structure is capable of being mated with the blade to limit a relative position of the blade with respect to the loading portion and/or the limiting wall. As the second base body slides, the loading portion is capable of reaching an in-use position and a replacement position. When the loading portion is at the in-use position, in a sliding direction of the second base body, the connection end is disposed between the first end and the second end, and a first distance is formed between the third end and the free end in the thickness direction. When the loading portion is at the replacement position, in the sliding direction of the second base body, at least part of the connection end is disposed at a side of the first end away from the second end, a second distance is formed between the third end and the free end in the thickness direction; and the second distance is greater than the first distance.

### BRIEF DESCRIPTION OF THE DRAWINGS

Illustrative embodiments of the present disclosure are described in detail below with reference to the attached drawing figures.

FIG. 1 is a first overall structural schematic view of a scraper according to a first embodiment of the present disclosure.

FIG. 2 is a second overall structural schematic view of the scraper according to the first embodiment of the present disclosure.

FIG. 3 is an exploded schematic view of the scraper according to the first embodiment of the present disclosure.

FIG. 4 is a first cross-sectional view of the scraper according to the first embodiment of the present disclosure.

FIG. 5 is a second cross-sectional view of the scraper according to the first embodiment of the present disclosure.

FIG. 6 is a structural schematic view of a first base body according to the first embodiment of the present disclosure.

FIG. 7 is a cross-sectional view of the first base body according to the first embodiment of the present disclosure.

FIG. 8 is a structural schematic view of a second base body according to the first embodiment of the present disclosure.

FIG. 9 is a schematic view of assembling the second base body to the first base body according to the first embodiment of the present disclosure.

FIG. 10 is a first structural schematic view of a blade according to some embodiments of the present disclosure.

FIG. 11 is a second structural schematic view of the blade according to some embodiments of the present disclosure.

FIG. 12 is a third structural schematic view of the blade according to some embodiments of the present disclosure.

FIG. 13 is an overall structural schematic view of the scraper according to a second embodiment of the present disclosure

FIG. 14 is a structural schematic view of the second base body and a limiting wall according to the second embodiment of the present disclosure.

FIG. 15 is a first side plane view of the second base body and the limiting wall according to the second embodiment of the present disclosure.

FIG. 16 is a second side plane view of the second base body and the limiting wall according to the second embodiment of the present disclosure.

### REFERENCE NUMERALS IN THE DRAWINGS

1—blade; 10—blade body; 11—cutting portion; 12—engagement portion; 121 first engagement portion; 122—second engagement portion;
2—first base body; 200—installation cavity; 201—first end; 202—second end; 203—first wall; 204—second wall; 205—side wall; 210—guide hole; 23—installation notch; 24—first limiting structure; 240—limiting groove; 2402—limiting surface; 2403—first limiting segment; 2404—second limiting segment; 2405—guiding segment;
3—second base body; 32—connection portion; 320—connection body; 321—button; 33—loading portion; 331—third end; 332—fourth end; 34—second limiting structure; 340—limiting protrusion; 35—engagement structure; 351—engagement protrusion; 352—engagement groove; 36—mating rotation shaft;
4—limiting wall; 40—connection end; 400—rotation hole; 41—free end; 42—receiving groove;
D1—first distance; D2—second distance; d1—distance between the first limiting segment and the limiting wall in the thickness direction; d2—distance between the second limiting segment and the limiting wall in the thickness direction.

### DETAILED DESCRIPTION

The following describes some non-limiting exemplary embodiments of the disclosure with reference to the accompanying drawings. The described embodiments are merely a part rather than all of the embodiments of the disclosure. All other embodiments obtained by a person of ordinary skill in the art based on the embodiments of the disclosure shall fall within the scope of the disclosure.

Unless otherwise defined, all technical and scientific terms used herein have the same meaning as commonly understood by those skilled in the art to which the present disclosure belongs. The terms used in the description of the present disclosure herein are intended for describing particular embodiments only and are not intended to limit the present disclosure. In the description, claims, and the above drawings of the present disclosure, the terms “including” and “having”, as well as their variants, are intended to convey a non-exclusive inclusion. The terms “first”, “second”, etc., as used herein, are intended to distinguish between different objects, rather than to describe a particular order.

Reference to “embodiments” herein implies that a particular feature, structure, or characteristic described in conjunction with an embodiment may be included in at least one embodiment of the present disclosure. The appearance of the phrase at various places in the specification does not necessarily refer to the same embodiment, nor is it a separate or an alternative embodiment that is mutually exclusive of other embodiments. One skilled in the art would explicitly and implicitly understand that the embodiments described herein can be combined with other embodiments.

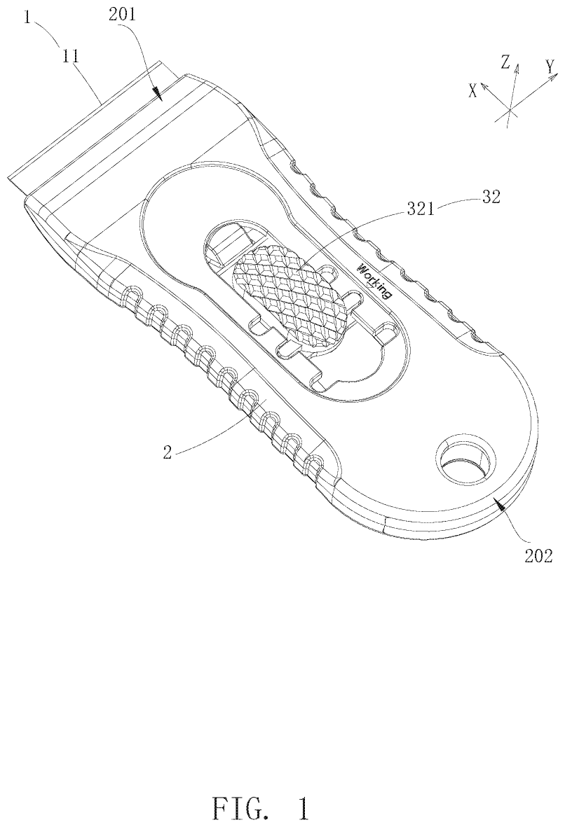

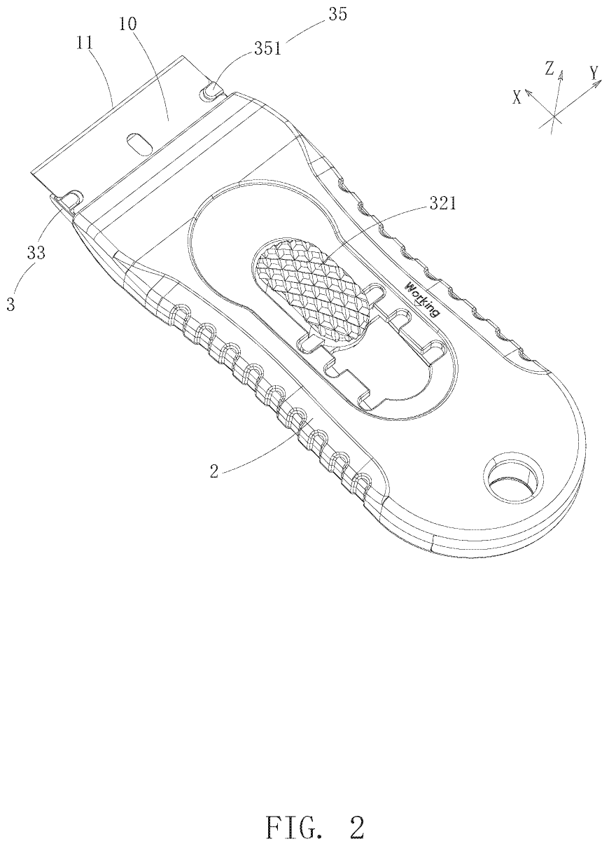

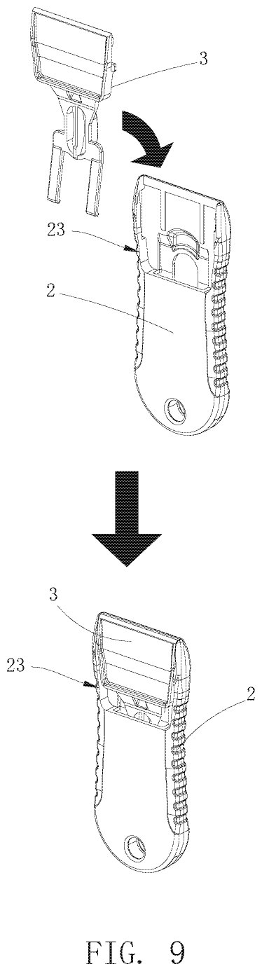

As shown in FIGS. 1 to 12, a first embodiment of the present disclosure may provide a scraper, which may include a first base body 2 and a second base body 3. The first base body 2 may have a first end 201 and a second end 202 away from the first end 201. The first base body 2 may include a limiting wall 4 disposed at or near the first end 201. The second base body 3 may include a connection portion 32 and a loading portion 33. The connection portion 32 may be slidably connected with the first base body 2. The loading portion 33 and the limiting wall 4 may cooperatively load a blade 1. The loading portion 33 may have a third end 331 away from the connection portion 32 and a fourth end 332 near the connection portion 32. At least one of the loading portion 33 and the limiting wall 4 may be arranged with an engagement structure 35. The engagement structure 35 may be engaged with the blade 1 to limit a relative position of the blade 1 with respect to the loading portion 33 and/or the limiting wall 4. As the second base body 3 slides, the loading portion 33 may reach an in-use position and a replacement position. When the loading portion 33 is at the in-use position, a distance between the third end 331 and the limiting wall 4 in a thickness direction of the scraper may be a first distance D1. When the loading portion 33 is at the replacement position, the distance between the third end 331 and the limiting wall 4 in the thickness direction of the scraper may be a second distance D2. The second distance D2 may be greater than the first distance D1.

Specifically, the first base body 2 may serve as a housing, a bracket, or a mounting seat of the scraper and may be configured to support and limit a sliding path of the second base body 3. The first end 201 may be a blade-output side of the scraper, and the second end 202 may be an end away from the blade-output side. A direction extending from the first end 201 to the second end 202 may be a length direction of the scraper (shown as an X direction in FIG. 1). The thickness direction of the scraper (shown as a Z direction in FIG. 1) may be a direction in which the limiting wall 4 and the loading portion 33 face each other or may be a direction in which the blade 1 is pressed or clamped by the loading portion 33 and the limiting wall 4. The width direction of the scraper (shown as a Y direction in FIG. 1) may be a direction perpendicular to both the length direction and the thickness direction. The connection portion 32 may be slidably connected to the first base body 2 through a slide groove, a guide rib, a slide rail, a cavity, or any other slide fitting structure, such that the loading portion 33 may be switched between the in-use position and the replacement position relative to the first base body 2. A sliding direction of the second base body 3 may be the same as the length direction of the scraper. For explanation, when the loading portion 33 reaches the in-use position as the second base body 3 slides, a position at which the blade 1 is located may be referred to as an in-use position of the blade 1. When the loading portion 33 reaches the replacement position as the second base body 3 slides, a position at which the blade 1 is located may be referred to as a replacement position of the blade 1. The loading portion 33 may be configured carry the blade 1, and the limiting wall 4 may be configured to limit or press the blade 1 from a side of the blade in the thickness direction. Therefore, the blade 1 may be at least partially maintained between the loading portion 33 and the limiting wall 4. Along a blade-output direction, the third end 331 may be an end of the loading portion 33 near of a blade-output side of the scraper, and the fourth end 332 may be an end of the loading portion 33 away from the blade-output side of the scraper. The blade 1 may have specifications or structural forms. For example, the blade 1 may be arranged with a cladding at a side away from the cutting portion 11. Alternatively, the blade 1 may be arranged without any cladding but arranged with a hole, a groove, or a notch to be mated with the loading portion 33. Alternatively, the blade 1 may be arranged with a cladding and may define a hole, a groove, or a notch. The engagement structure 35 may be a protrusion, a recess, a notch, a rib, a slot, a block, or a combination of at least two of the above. The engagement structure 35 may be configured to be mated with the hole, the groove, the notch, the cladding, a protruding edge, or any other positioning element arranged on the blade 1, so as to limit the blade 1 from moving relative to the loading portion 33 in the length direction and/or the width direction.

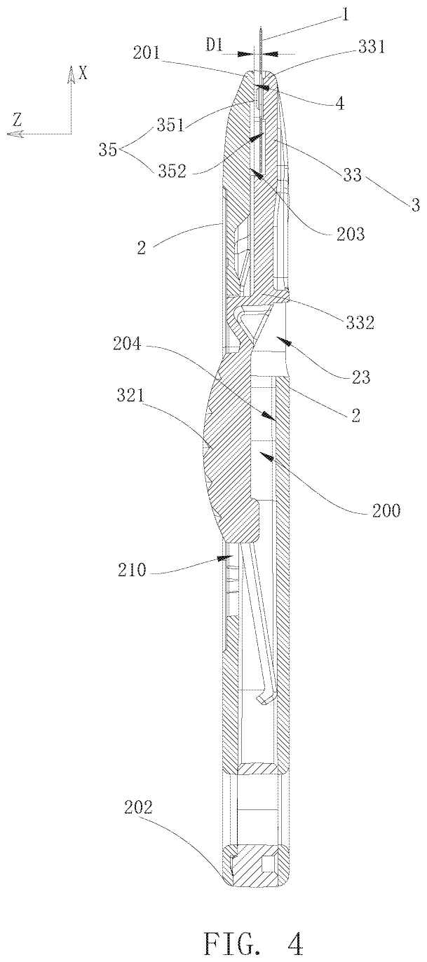

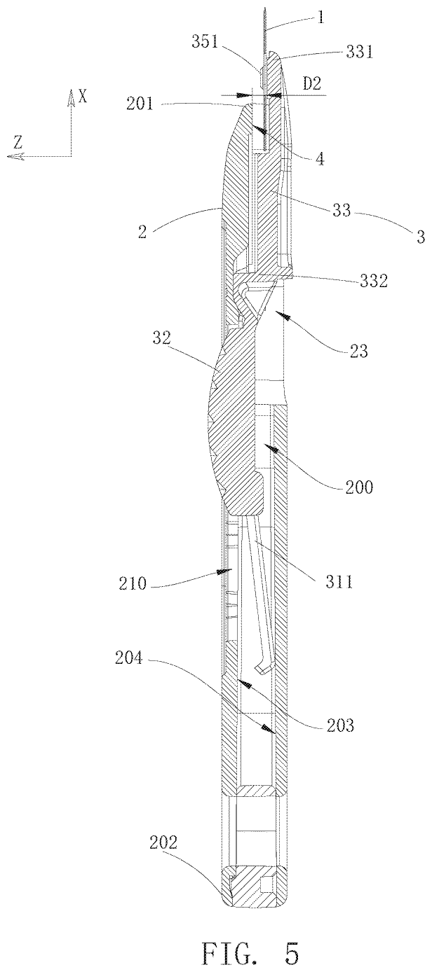

As shown in FIG. 4, when the loading portion 33 is at the in-use position, the distance between the third end 331 and the limiting wall 4 in the thickness direction of the scraper may be the first distance D1. The first distance D1 may be set to enable the loading portion 33 and the limiting wall 4 to tightly clamp or limit the blade 1 in the thickness direction, such that the blade 1 may be less likely to shake or disengage from the loading portion 33 during scraping, cutting, or trimming an object. As shown in FIG. 5, when the loading portion 33 is at the replacement position, the distance between the third end 331 and the limiting wall 4 in the thickness direction of the scraper may be increased to be the second distance D2, and the second distance D2 may be greater than the first distance D1. The second distance D2 may at least allow the blade 1 with the cladding to be loaded between the loading portion 33 and the limiting wall 4. There are various ways to increase the distance to be the second distance D2. For example, when the loading portion 33 slides from the in-use position to the replacement position, the loading portion 33 may be displaced in the thickness direction to increase the distance between the third end 331 and the limiting wall 4. Alternatively, the loading portion 33 may be connected to the connection portion 32 via a rotation shaft, such that the loading portion 33 may rotate relative to the connection portion 32 about the rotation shaft, causing the third end 331 of the loading portion 33 to move away from the limiting wall 4. Therefore, the distance between the third end 331 and the limiting wall 4 may be increased.

Accordingly, in the in-use position, the loading portion 33 and the limiting wall 4 may stably clamp or load the blade 1 due to having the first distance D1 therebetween; and in the replacement position, the loading portion 33 and the limiting wall 4 may provide a larger loading/unloading space as the second distance D2 is greater. In this way, blades 1 in various specifications or structural forms may be loaded or removed easily. Adaptability of the scraper to various blades 1 may be improved, the blade 1 may be replaced more conveniently, and the user experience may be improved.

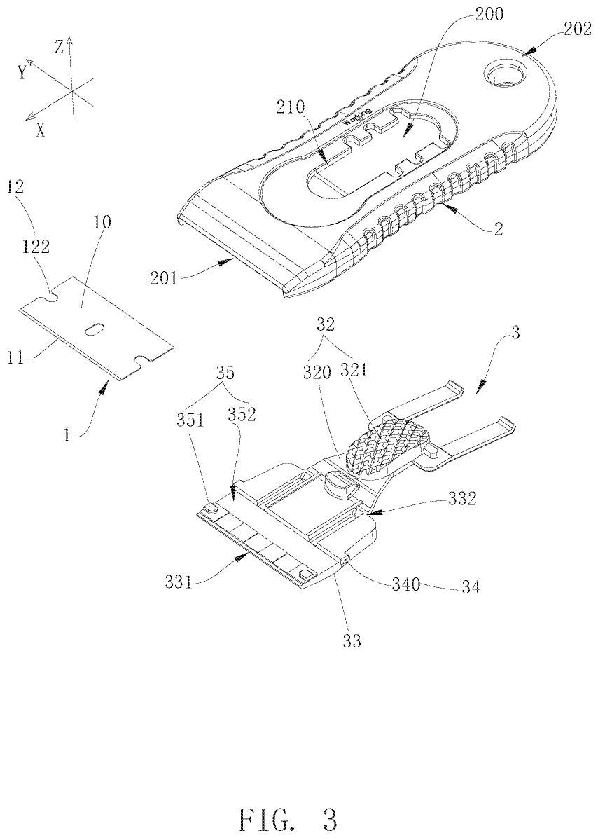

As shown in FIGS. 3 to 12, in some embodiments, the scraper may further include at least one blade 1. The blade 1 may include a blade body 10 and a cutting portion 11 arranged on one side of the blade body 10. At least part of the blade body 10 may be disposed between the loading portion 33 and the limiting wall 4, and at least part of the cutting portion 11 may extend beyond the third end 331.

Specifically, the blade 1 may be a replaceable consumable for the scraper. The scraper may be sold together with one or more blades 1. For example, a plurality of blades 1 may be packaged in a box or as a set and sold together with the scraper body. Alternatively, the scraper may be sold alone, or the blades 1 compatible with the scraper may be sold separately. The blade body 10 may serve as a supporting portion of the blade 1 to be mated with the loading portion 33 and the limiting wall 4 for loading. The cutting portion 11 may be used for scraping, cutting, trimming, or opening an object. At least part of the cutting portion 11 may extend beyond the third end 331 of the loading portion 33, such that the cutting portion 11 may form an exposed or extended region usable for work after the blade 1 is loaded to the scraper. The blade 1 may be made of metal, plastic, or other materials with a certain hardness. For example, in scenarios where high sharpness or durability may be needed, a metal blade 1 may be used; in scenarios where a risk of scratching needs to be reduced and light scraping or package opening are to be performed, a plastic blade 1 may be applied. Therefore, the scraper may be arranged with the blade 1 of a suitable material or specification according to a current application scenario, and the blade body 10 may be loaded or limited by the loading portion 33 and the limiting wall 4. In this way, the scraper may be used more flexibly.

As shown in FIGS. 3 to 12, in some embodiments, the engagement structure 35 may include an engagement protrusion 351 and an engagement groove 352. The engagement protrusion 351 may be arranged on the loading portion 33 and near the third end 331. The engagement groove 352 may be defined in at least one of the loading portion 33 and the limiting wall 4 and may be closer to the fourth end 332 than the engagement protrusion 351. When the loading portion 33 is at the in-use position, both the engagement groove 352 and the engagement protrusion 351 may be disposed between the first end 201 and the second end 202, and the engagement protrusion 351 may be at least partially shielded by the limiting wall 4. When the loading portion 33 is at the replacement position, the engagement protrusion 351 may be located beyond the first end 201. The blade 1 may further include an engagement portion 12. The engagement portion 12 may be mated with at least one of the engagement protrusion 351 and the engagement groove 352, so as to limit the relative position of the blade 1 with respect to the loading portion 33.

For explanation, the present embodiment may be described as the engagement groove 352 and the engagement protrusion 351 both arranged on the loading portion 33. Specifically, the engagement groove 352 may be recessed in a surface of the loading portion 33 and may extend in the width direction of the scraper or penetrate the loading portion 33 in the width direction. The engagement groove 352 may be used to accommodate the blade 1 with the protruding engagement portion 12 such as cladding or the protruding edge. The engagement portion 12 of the blade 1 may be received in the engagement groove 352, such that the blade 1 may be limited from moving relative to the loading portion 33 in the length direction of the scraper, and possibility of the blade 1 shifting or misaligning in the length direction during use may be reduced. The engagement protrusion 351 may protrude from the surface of the loading portion 33 toward the limiting wall 4. One engagement protrusion 351 may be arranged, or a plurality of engagement protrusions 351 may be arranged at intervals in the width direction of the scraper. The engagement protrusion 351 may be applicable for the blade 1 with a recessed engagement portion 12 such as a notch, a hole, or a groove. The engagement portion 12 of the blade 1 may be engaged or fit with the engagement protrusion 351, such that the blade 1 may be limited from moving relative to the loading portion 33 in the length direction and/or the width direction of the scraper. Therefore, by arranging both the engagement groove 352 and the engagement protrusion 351 on the loading portion 33, the scraper may be applicable for: the blade 1 with the cladding or protruding edge; the blade 1 having the notch, the hole, or the groove; and the blade 1 having a plurality of types of engagement portions 12 as describe in the above. Therefore, adaptability of the scraper to blades 1 of various specifications or structural forms may be improved.

Further, the limiting wall 4 and the loading portion 33 may be arranged opposite to each other in the thickness direction of the scraper, and a clamping gap for loading the blade 1 may be formed therebetween. When the loading portion 33 is at the in-use position, the first distance D1 may be formed between the third end 331 and the limiting wall 4, and the first distance D1 may enable the loading portion 33 and the limiting wall 4 to stably clamp or limit the blade 1 in the thickness direction. The first distance D1 may be adapted to a thickness of the blade 1, such that the loading portion 33 and the limiting wall 4 may clamp, press, or limit the blade 1 in the thickness direction. However, since the engagement protrusion 351 protrudes toward the limiting wall 4, if the first distance D1 is not changed when the loading portion 33 is at the replacement position, the clamping gap may be small. When the blade 1 with the cladding is to be inserted from a lateral side in the width direction of the loading portion 33, the cladding of the blade 1 may be easily blocked by the engagement protrusion 351, such that the blade 1 may not be easily received in the engagement groove 352 or inserted into the clamping gap. Therefore, when the loading portion 33 is at the replacement position, the greater second distance D2 may be formed between the third end 331 and the limiting wall 4, and the engagement protrusion 351 may be disposed beyond the first end 201 of the first base body 2, and that is, the engagement protrusion 351 may be disposed at a side of the first end 201 away from the second end 202. In this way, the engagement protrusion 351 may be at least partially disposed out of a shielding range of the limiting wall 4. At this moment, the blade 1 with cladding may be loaded from the blade-output side near the first end 201 along the length direction of the scraper toward the second end 202 to be disposed between the loading portion 33 and the limiting wall 4, and the cladding of the blade 1 may be received in the engagement groove 352. In this way, the blade 1 may be smoothly loaded. When the loading portion 33 is at the in-use position, both the engagement groove 352 and the engagement protrusion 351 may be disposed between the first end 201 and the second end 202, and the engagement protrusion 351 may be at least partially shielded by the limiting wall 4, such that the engagement portion 12 of the blade 1 may not be easily disengaged from the engagement groove 352 or the engagement protrusion 351, and the blade 1 may be stably held between the loading portion 33 and the limiting wall 4.

Accordingly, with the first distance D1, the loading portion 33 and the limiting wall 4 may clamp the blade more stably at the in-use position, and the scraper may be used more reliably. The second distance D2 may increase the loading/unloading space at the replacement position, and obstruction, caused by the engagement protrusion 351, against insertion of the blade 1 with the protruding engagement portion 12 such as cladding. In this way, the blade 1 may be stably loaded during use and may be conveniently loaded/unloaded during replacement. Adaptability of the scraper to various blades 1 of various specifications or structural forms may be improved. It should also be noted that in other embodiments, the engagement groove 352 may be defined in the limiting wall 4, or in both the limiting wall 4 and the loading portion 33.

As shown in FIGS. 3 to 12, in some embodiments, the engagement portion 12 may include a first engagement portion 121 protruding from the blade body 10, and the first engagement portion 121 may be engaged in the engagement groove 352. The first engagement portion 121 may be the cladding arranged on the side of the blade body 10 away from the cutting portion 11.

Specifically, the first engagement portion 121 may be a structure protruding relative to the surface of the blade body 10 and may extend in the width direction of the scraper to be engaged with the engagement groove 352 extending in the width direction. The first engagement portion 121 may be the cladding, such as a metal cladding arranged on the side of the blade body 10 away from the cutting portion 11. The first engagement portion 121 may alternatively be a protruding edge, a folded edge, a reinforcing edge, or any other protruding structure that may be received in the engagement groove 352. When the blade 1 is loaded on the loading portion 33, at least part of the first engagement portion 121 may be received in the engagement groove 352, and a groove wall of the engagement groove 352 may limit the first engagement portion 121, so as to limit the blade 1 from moving relative to the loading portion 33 in the length direction of the scraper. Therefore, for the blade 1 with the cladding or any other protruding engagement portion 12, the blade 1 may be stably loaded on the loading portion 33 by enabling the first engagement portion 121 to be mated with the engagement groove 352. Therefore, the blade 1 may be positioned more stably during use.

As shown in FIGS. 3 to 12, in some embodiments, the engagement portion 12 may include at least two second engagement portions 122 recessed in the blade body 10. The engagement structure 35 may include at least two engagement protrusions 351. The at least two second engagement portions 122 may be engaged with the at least two engagement protrusions 351. The at least two second engagement portions 122 and the at least two engagement protrusions 351 may be in one-to-one correspondence with each other.

Specifically, each of the at least two second engagement portions 122 may be a notch formed at the edge of the blade body 10, or a hole, a groove, or any other recessed structure formed in the blade body 10. The number of the at least two second engagement portions 122 may be two, three, or more, and the number of the at least two engagement protrusions 351 may be equal to the number of the at least two second engagement portions 122. When the blade 1 is loaded on the loading portion 33, each of the at least two second engagement portions 122 may be engaged, fit, or mated with a respective one of the at least two engagement protrusions 351. Therefore, the engagement protrusion 351 may limit the blade 1 through the second engagement portion 122, limiting the blade 1 from moving relative to the loading portion 33 in the length direction and/or the width direction of the scraper. Accordingly, for the blade 1 with the recessed engagement portions 12 such as notches, holes, or grooves, the second engagement portions 122 may be engaged with the engagement protrusions 351 to stably load the blade 1 on the loading portion 33, reducing possibility of the blade 1 shifting, misaligning, or disengaging during use.

As shown in FIGS. 3 to 12, in some embodiments, the engagement portion 12 may include the first engagement portion 121 protruding from the blade body 10 and the second engagement portion 122 recessed in the blade body 10. The first engagement portion 121 may be engaged in the engagement groove 352, and the second engagement portion 122 may be engaged with the engagement protrusion 351. When the loading portion 33 is at the replacement position, the second distance D2 may allow the first engagement portion 121 to pass over the engagement protrusion 351 to be received in or disengaged out of the engagement groove 352.

Specifically, for the blade 1 having both the first engagement portion 121 and the second engagement portion 122, the first engagement portion 121 and the second engagement portion 122 may be spaced apart from each other in the length direction of the scraper and respectively engaged with the engagement groove 352 and the engagement protrusion 351. When loading the blade 1, the blade 1 may be disposed between the loading portion 33 and the limiting wall 4 when the loading portion 33 is at the replacement position. Since the greater second distance D2 may be formed between the third end 331 and the limiting wall 4 at the replacement position, even when the first engagement portion 121 is a structure protruding relative to the blade body 10, a sufficient clearance space may be provided in the thickness direction for the first engagement portion 121 to pass over the engagement protrusion 351 near the third end 331 to be engaged in the engagement groove 352. At the same time, the second engagement portion 122 may be engaged with the engagement protrusion 351. When removing the blade 1, the first engagement portion 121 may be disengaged from the engagement groove 352 through the loading/unloading space provided by the second distance D2 and may then be removed after passing over the engagement protrusion 351. Therefore, even when the engagement groove 352 does not extend beyond the first end 201, the second distance D2 may be formed to provide the clearance space for the first engagement portion 121 to be inserted in and removed out of the scraper. The blade 1 having both the first engagement portion 121 and the second engagement portion 122 may be smoothly loaded and unloaded and may be stably limited through the engagement groove 352 and the engagement protrusion 351 at the in-use position.

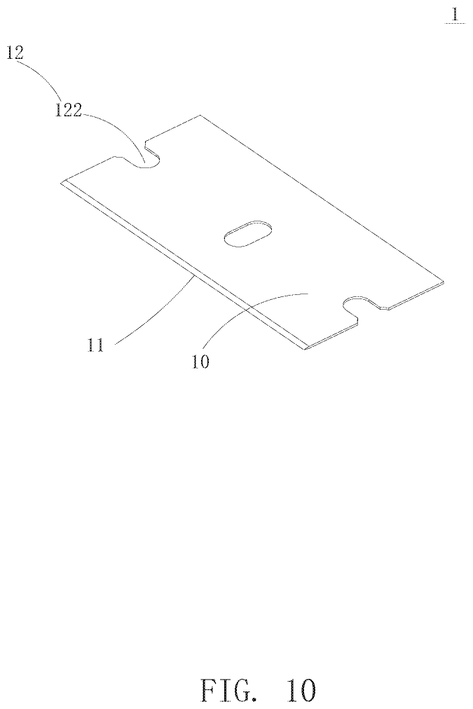

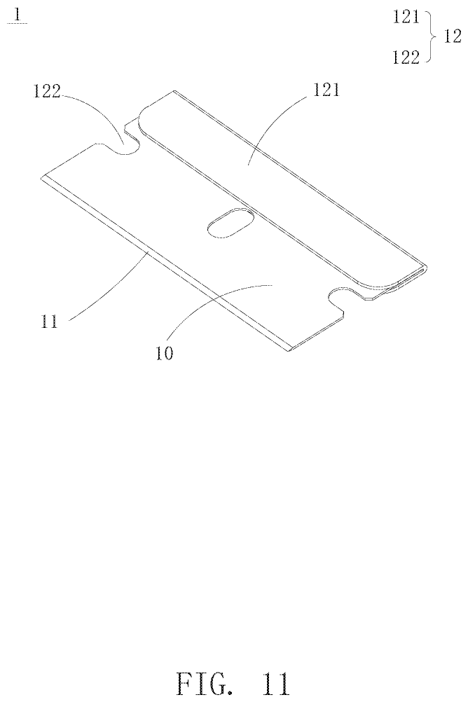

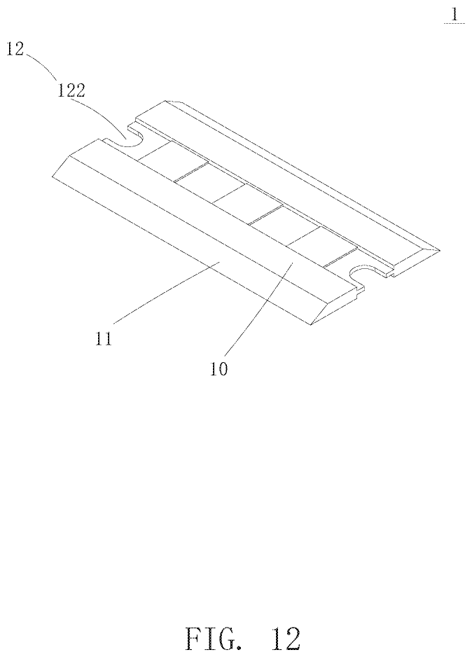

In summary, blades may be grouped as at least two types, based on presence or absence of the first engagement portion 121. For a first type, the blade may have the first engagement portion 121 as shown in FIG. 11. For a second type, the blade 1 may not have the first engagement portion 121 as shown in FIGS. 10 and 12. Alternatively, the blades may be grouped as at least two types, based on a material of the blade 1. For a first type, the blade may be a relatively thin blade 1 as shown in FIGS. 10 and 11 and may be made of metal. For a second type, the blade 1 may be a relatively thick blade 1 as shown in FIG. 12 and may be made of plastic. Due to arrangement of the engagement protrusion 351, regardless of any type of blade 1 mentioned above, any blade may be arranged with the second engagement portion 122 engaged with the engagement protrusion 351.

As shown in FIGS. 1, 5 to 9, in some embodiments, the first base body 2 may include a first wall 203 and a second wall 204 opposite to the first wall 203 in the thickness direction. An installation cavity 200 may be formed between the first wall 203 and the second wall 204, and the limiting wall 4 may be formed at a position of the first wall 203 near the first end 201. The first base body 2 may further include a guide hole 210 defined in the first wall 203. The guide hole 210 may communicate the installation cavity 200 with an outside of the scraper. The guide hole 210 may be elongated and extend along the sliding direction of the second base body 3. The connection portion 32 may include a connection body 320 and a button 321 arranged on the connection body 320. The connection body 320 may be slidably received in the installation cavity 200, and at least part of the button 321 may pass through the guide hole 210 and may be exposed through the guide hole 210.

Specifically, the first wall 203 and the second wall 204 may be spaced apart from each other in the thickness direction of the scraper, and the installation cavity 200 may receive at least part of the connection body 320 and provide an installation space for the connection body 320 to slide relative to the first base body 2. The first wall 203 may be a wall near a user operation side, and the second wall 204 may be a wall opposite to the first wall 203. The limiting wall 4 may be formed at the position of the first wall 203 near the first end 201 and may be opposite to the loading portion 33 in the thickness direction, such that the limiting wall 4 and the loading portion 33 may cooperatively load the blade 1. The guide hole 210 may extend along the sliding direction of the second base body 3, and the button 321 may pass through and may be exposed from the guide hole 210. In this way, the user may push the button 321 to drive the connection body 320 to slide relative to the first base body 2, so as to drive the loading portion 33 to switch between the in-use position and the replacement position. The guide hole 210 may guide and limit a sliding path of the button 321, and therefore, the second base body 3 may slide relative to the first base body 2 more stably.

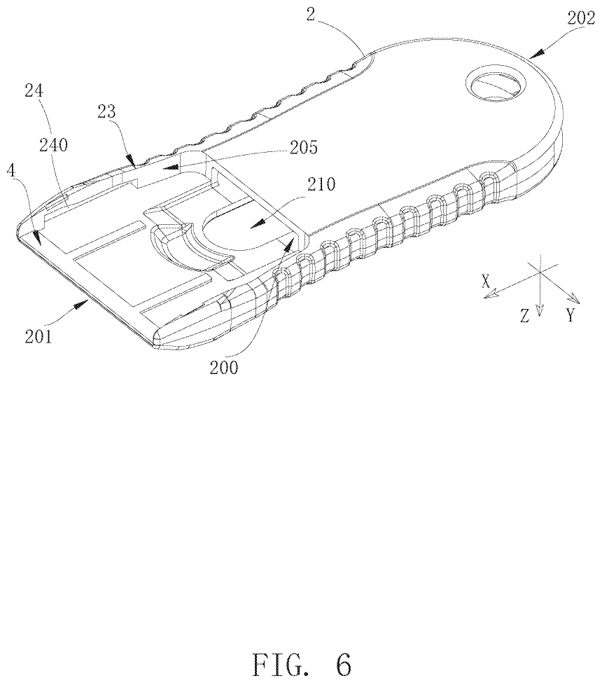

As shown in FIG. 6, in some embodiments, the first base body 2 may further include two side walls 205 connected to the first wall 203 and the second wall 204. The first base body 2 may further include an installation notch 23 defined in the second wall 204. The installation notch 23 may be communicated with the installation cavity 200. An end of the installation notch 23 near the first end 201 may penetrate the first end 201 of the first base body 2. The button 321 and the loading portion 33 may be misaligned with each other in the thickness direction. At least part of the loading portion 33 may be received in the installation notch 23, and the loading portion 33 and the limiting wall 4 may cooperatively load the blade 1.

Specifically, the two side walls 205 may be arranged opposite to each other in the width direction of the scraper and connected between the first wall 203 and the second wall 204. In this way, the two side walls 205, the first wall 203 and the second wall 204 may cooperatively define the installation cavity 200. The installation notch 23 may be formed in the second wall 204 near the first end 201 and may be communicated with the installation cavity 200, so as to provide an installation and movement space for the loading portion 33. Since the end of the installation notch 23 near the first end 201 penetrates the first end 201 of the first base body 2, the loading portion 33 may be at least partially exposed or extended out of the first base body 2 at a position near the first end 201, enabling the blade 1 to be easily loaded between the loading portion 33 and the limiting wall 4 at the replacement position. The button 321 and the loading portion 33 are misaligned with each other in the thickness direction, and therefore, the button 321 may pass through the guide hole 210 in the first wall 203 to be operated by the user. Furthermore, the loading portion 33 may be at least partially received in the installation notch 23 of the second wall 204 and may work cooperatively with the limiting wall 4 formed on the first wall 203 in the thickness direction. Therefore, while the button 321 may be operated conveniently, arrangement of a space for loading the blade may be achieved. When the loading portion 33 is at the in-use position, the two side walls 205 may close or block two ends of the engagement groove 352 in the width direction, such that the first engagement portion 121 of the blade 1 may be less likely to be disengaged from or shift relative to the engagement groove 352 in the width direction. Therefore, stability of loading the blade 1 at the in-use position may be improved.

By defining the installation notch 23 in the second wall 204 and receiving at least part of the loading portion 33 in the installation notch 23, a space occupied by the loading portion 33 in the thickness direction of the installation cavity 200 may be reduced, an overall thickness of the scraper may be reduced. At the same time, the installation notch 23 may be communicated with the installation cavity 200 and may penetrate the first end 201, such that a sufficient clearance space may be provided for the loading portion 33 when sliding between the in-use position and the replacement position, facilitating assembling and sliding of the second base body 3 relative to the first base body 2, and facilitating loading and unloading of the blade 1 from a side near the first end 201 at the replacement position. Moreover, at the in-use position, the two side walls 205 and the engagement groove 352 may work cooperatively to limit the first engagement portion 121 in the width direction, further reducing possibility of the blade 1 shifting or misaligning in the width direction.

As shown in FIG. 6, in some embodiments, the guide hole 210 may extend toward the first end 201, and a projection of the guide hole 210 on a first projection plane and a projection of the installation notch 23 on the first projection plane may at least partially overlap with each other. The first projection plane may be a plane perpendicular to the thickness direction.

Specifically, the first projection plane may be specifically an XY plane as shown in FIG. 6. The projection of the guide hole 210 on the first projection plane and the projection of the installation notch 23 on the first projection plane may at least partially overlap with each other, and therefore, the guide hole 210 and the installation notch 23 may be positionally corresponding or substantially positionally corresponding to each other in the thickness direction. Therefore, when the second base body 3 is installed into the first base body 2 or slides relative to the first base body 2, the button 321 arranged on the connection body 320 may relatively smoothly enter the guide hole 210, and the loading portion 33 may relatively smoothly enter or move into the installation notch 23, reducing possibility of the button 321 and the loading portion 33 causing structural interference with the button 321. Therefore, the loading portion 33 may be assembled to and slide relative to the first base body 2 more smoothly.

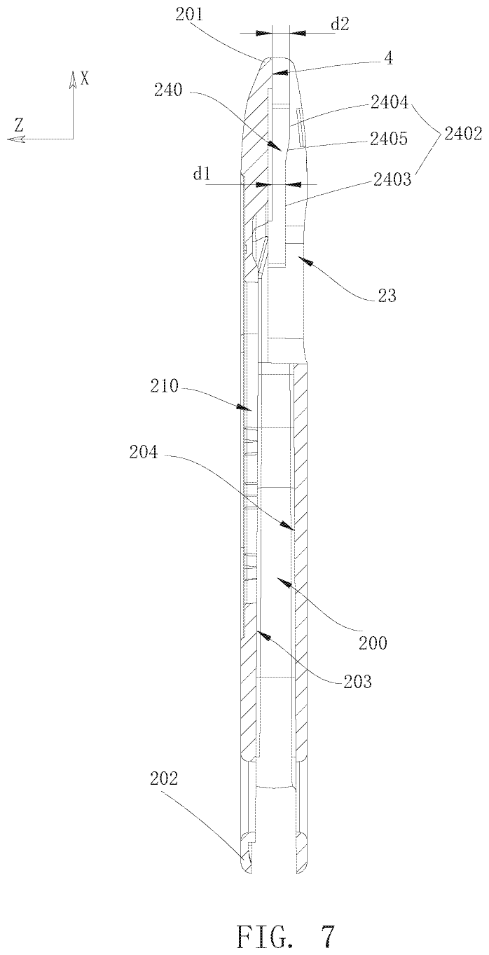

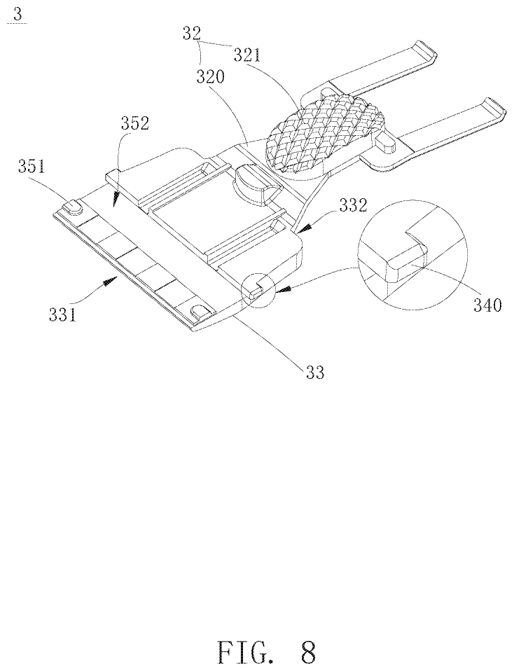

As shown in FIGS. 7 and 8, in some embodiments, the first base body 2 may include a first limiting structure 24 arranged on at least one of the two side walls 205, and the second base body 3 may include a second limiting structure 34 arranged on the loading portion 33. The first limiting structure 24 and the second limiting structure 34 may be slidably mated with each other to limit the loading portion 33 from disengaging from the installation notch 23 in the thickness direction. One of the first limiting structure 24 and the second limiting structure 34 may be a limiting groove 240 extending along the sliding direction, and the other one of the first limiting structure 24 and the second limiting structure 34 may be a limiting protrusion 340.

Specifically, the first limiting structure 24 may be disposed on a side of the side wall 205 facing the loading portion 33, and the second limiting structure 34 may be disposed at a lateral side of the loading portion 33. The first limiting structure 24 and the second limiting structure 34 may be slidably mated with each other when the second base body 3 slides relative to the first base body 2. The limiting groove 240 may extend along the sliding direction of the second base body 3, and the limiting protrusion 340 may extend into the limiting groove 240 and slide along the limiting groove 240. Therefore, mating between the limiting groove 240 and the limiting protrusion 340 may allow the loading portion 33 to move (as the second base body 3 slides) in the sliding direction between the in-use position and the replacement position and may limit the loading portion 33 from disengaging from the first base body 2 through the installation notch 23 in the thickness direction of the scraper. In this way, the second base body 3 may be assembled to the first base body 2 more stably and may slide relative to the first base body 2 more reliably.

As shown in FIGS. 4, 5, and 7, in some embodiments, the first base body 2 may define the limiting groove 240, the second base body 3 may be arranged with the limiting protrusion 340, and the limiting protrusion 340 may slide within the limiting groove 240. The limiting groove 240 may include a limiting surface 2402 opposite to the limiting wall 4 in the thickness direction. The limiting surface 2402 may include a first limiting segment 2403 and a second limiting segment 2404 connected to the first limiting segment 2403. The first limiting segment 2403 may be disposed away from the first end 201, and the second limiting segment 2404 may be disposed near the first end 201. A distance d1 between the first limiting segment 2403 and the limiting wall 4 in the thickness direction may be smaller than a distance d2 between the second limiting segment 2404 and the limiting wall 4 in the thickness direction. When the loading portion 33 is at the in-use position, the limiting protrusion 340 may abut against the first limiting segment 2403. When the loading portion 33 is at the replacement position, the limiting protrusion 340 may abut against the second limiting segment 2404, such that the second distance D2 may be greater than the first distance D1.

Specifically, in embodiments where the loading portion 33 is integrally formed or fixedly connected with the connection portion 32, the loading portion 33 may slide synchronously with the connection portion 32 relative to the first base body 2. The limiting groove 240 may extend along the sliding direction of the second base body 3, and the limiting surface 2402 may abut against the limiting protrusion 340 so as to define a position of the second base body 3 relative to the first base body 2 in the thickness direction. Since the distance d1 between the first limiting segment 2403 and the limiting wall 4 in the thickness direction may be smaller than the distance d2 between the second limiting segment 2404 and the limiting wall 4 in the thickness direction, when the limiting protrusion 340 slides to abut against the first limiting segment 2403, the loading portion 33 may be disposed close to the limiting wall 4, such that the smaller first distance D1 may be formed between the third end 331 and the limiting wall 4. Therefore, the loading portion 33 and the limiting wall 4 may cooperatively clamp or limit the blade 1 at the in-use position. When the limiting protrusion 340 slides to abut against the second limiting segment 2404, the loading portion 33 may be disposed away from the limiting wall 4 in the thickness direction, and the greater second distance D2 may be formed between the third end 331 and the limiting wall 4. Therefore, the loading portion 33 may provide a larger loading/unloading space at the replacement position, facilitating insertion or removal of the blade 1. Accordingly, even when the loading portion 33 is integrally formed or fixedly connected with the connection portion 32, the change in the distance between the loading portion 33 and the limiting wall 4 in the thickness direction at various positions may be achieved based on the first limiting segment 2403 and the second limiting segment 2404. Therefore, clamping stability of the blade at the in-use position may be ensured, and at the same time, the blade may be loaded/unloaded conveniently at the replacement position.

As shown in FIG. 7, in some embodiments, the limiting surface 2402 may further include a guiding segment 2405. The guiding segment 2405 may be connected between the first limiting segment 2403 and the second limiting segment 2404. The guiding segment 2405 may be inclined relative to the sliding direction of the second base body 3 to guide the limiting protrusion 340 to slide between the first limiting segment 2403 and the second limiting segment 2404.

Specifically, the guiding segment 2405 may serve as a transition structure between the first limiting segment 2403 and the second limiting segment 2404. Since the distance between the first limiting segment 2403 and the limiting wall 4 in the thickness direction may be smaller than the distance between the second limiting segment 2404 and the limiting wall 4 in the thickness direction, when the limiting protrusion 340 transits between the first limiting segment 2403 and the second limiting segment 2404, the limiting protrusion 340 may have a corresponding positional change in the thickness direction. The guiding segment 2405 may be inclined relative to the sliding direction of the second base body 3, such that the limiting protrusion 340 may gradually transit along the guiding segment 2405 to the first limiting segment 2403 or to the second limiting segment 2404. Therefore, sudden jumps, jamming, or excessive resistance during the guiding segment 2405 transiting between the first limiting segment 2403 and the second limiting segment 2404 may be reduced. A connection position between the guiding segment 2405 and the first limiting segment 2403 and a connection position between the guiding segment 2405 and the second limiting segment 2404 may be rounded or configured with a curved transition surface to further improve the smoothness of the sliding switching of the limiting protrusion 340. In this way, transition of the loading portion 33 between the first limiting segment 2403 and the second limiting segment 2404 may be performed more smoothly, such that the loading portion 33 may be switched between the in-use position and the replacement position more stably, and the user may have a better sense in operating the loading portion 33.

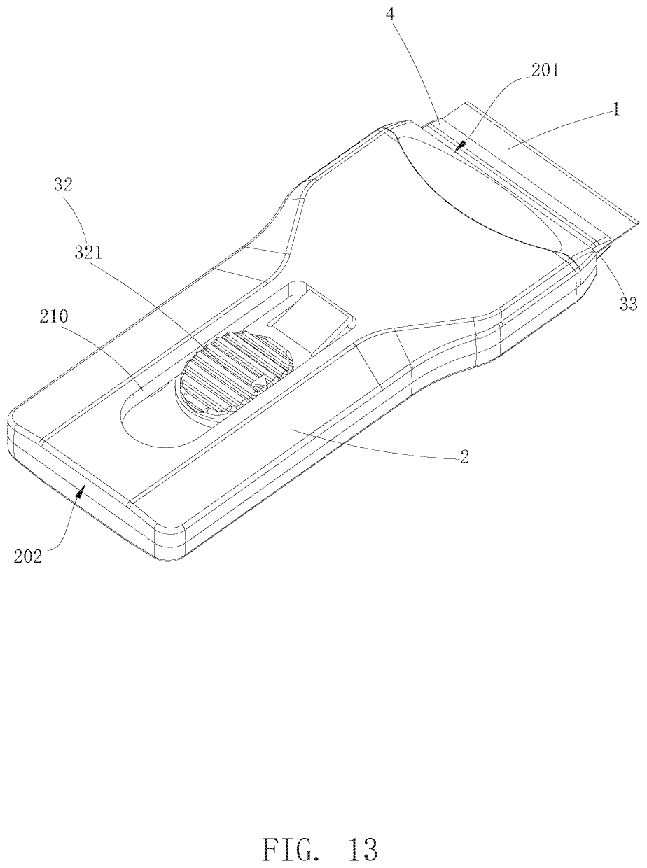

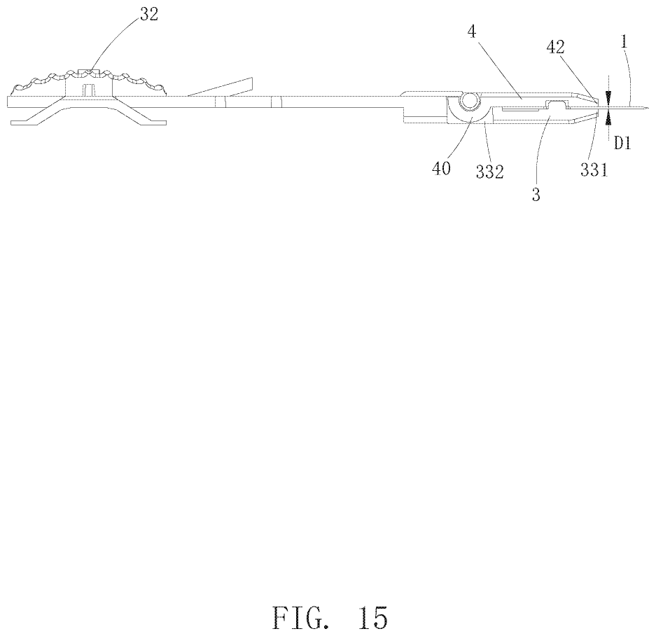

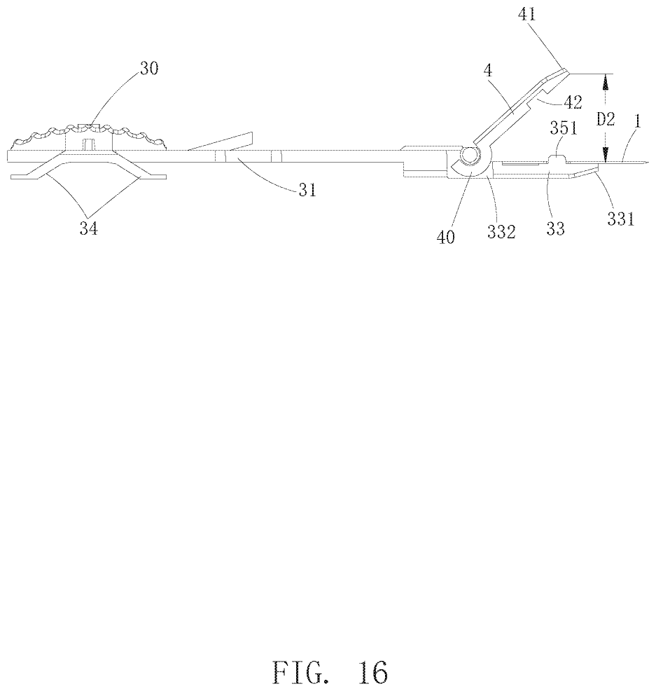

As shown in FIGS. 13 to 16, a second embodiment of the present disclosure may further provide the scraper, which may include the first base body 2, the second base body 3, and the limiting wall 4. The first base body 2 may have the first end 201 and the second end 202 away from the first end 201. The second base body 3 may include the connection portion 32 and the loading portion 33. The connection portion 32 may be slidably connected with the first base body 2. The loading portion 33 may have the third end 331 away from the connection portion 32 and the fourth end 332 near the connection portion 32. The limiting wall 4 may have a connection end 40 and a free end 41 away from the connection end 40. The connection end 40 may be connected to the second base body 3. The limiting wall 4 and the loading portion 33 may cooperatively load the blade 1. At least one of the loading portion 33 and the limiting wall 4 may be arranged with the engagement structure 35, and the engagement structure 35 may be engaged with the blade 1 to limit the relative position of the blade 1 with respect to the loading portion 33 and/or the limiting wall 4. As the second base body 3 slides, the loading portion 33 may slide to reach the in-use position and the replacement position. When the loading portion 33 is at the in-use position, in the sliding direction of the second base body 3, the connection end 40 may be disposed between the first end 201 and the second end 202, and the distance between the third end 331 and the free end 41 in the thickness direction may be the first distance D1. When the loading portion 33 is at the replacement position, in the sliding direction of the second base body 3, at least part of the connection end 40 may pass beyond the first end 201, and the distance between the third end 331 and the free end 41 in the thickness direction may be the second distance D2, and the second distance D2 may be greater than the first distance D1.

Specifically, a difference between the present embodiment and the first embodiment is that the limiting wall 4 is not formed on the first base body 2. In the present embodiment, the limiting wall 4 may be connected to the second base body 3, and the limiting wall 4 and the loading portion 33 may cooperatively load the blade 1. The limiting wall 4 may be an independent sheet, a pressing piece, an elastic piece, or a clamping piece. The connection end 40 may be connected to the second base body 3 by snap-fitting, insertion, hinged connection, rotatable connection, clamping connection, or any other connection manner. The free end 41 of the limiting wall 4 may be arranged opposite to the third end 331 of the loading portion 33, and the free end 41 and the loading portion 33 may cooperatively load or clamp the blade 1 in the thickness direction. When the loading portion 33 is at the in-use position, the connection end 40 of the limiting wall 4 may be disposed between the first end 201 and the second end 202. At this moment, the connection end 40 may be limited by a part of the first base body 2 near the first end 201, such that the limiting wall 4 may not be easily disengaged from the second base body 3 in the sliding direction, and the smaller first distance D1 may be formed between the free end 41 and the loading portion 33. In this way, the blade 1 may be loaded more stably at the in-use position. When the loading portion 33 is at the replacement position, at least part of the connection end 40 may pass beyond the first end 201, and limitation on the limiting wall 4 caused by the first base body 2 may be weakened or released, enabling the free end 41 to be disposed away from the loading portion 33, such that the second distance D2 greater than the first distance D1 may be formed. Specifically, the connection end 40 may rotate relative to the second base body 3, enabling the limiting wall 4 to be opened about the connection end 40. Alternatively, the limiting wall 4 itself may be an elastically deformable elastic plate, enabling the free end 41 to be elastically deflected at the replacement position. Alternatively, the connection end 40 may be connected to the second base body 3 through a snap-fitting or limiting structure, enabling a greater space may be provided for the limiting wall 4 to move after passing beyond the first end 201. Accordingly, in the present embodiment, the blade 1 may be stably loaded through the first distance D1 at the in-use position, and a larger loading/unloading space may be provided through the second distance D2 at the replacement position. Therefore, blades 1 of various specifications or structural forms may be easily inserted or removed, adaptability of the scraper may be improved, and the blade for the scraper may be replaced more conveniently.

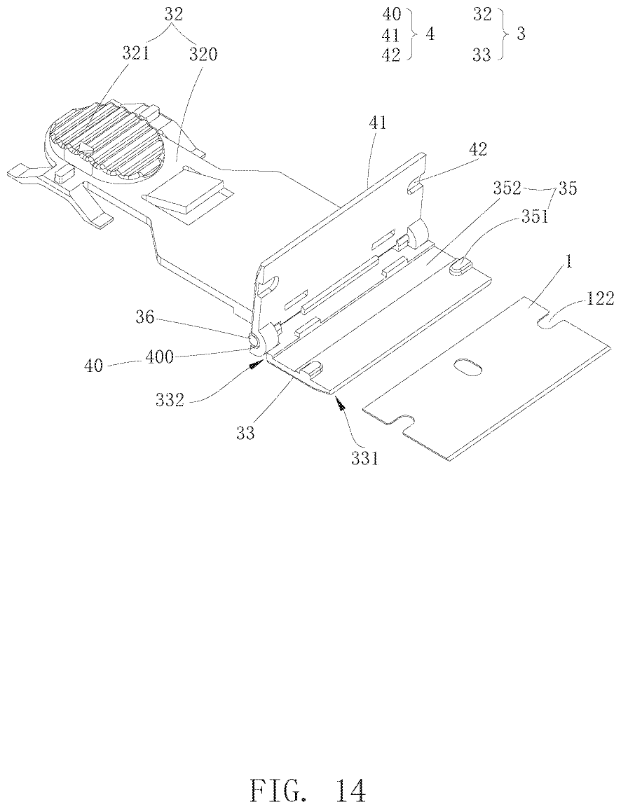

As shown in FIGS. 14 to 16, in some embodiments, the connection end 40 of the limiting wall 4 may be rotatably connected to the second base body 3. When the loading portion 33 is at the replacement position, the limiting wall 4 may rotate relative to the second base body 3, such that the second distance D2 may be greater than the first distance D1.

Specifically, the second base body 3 may be arranged with a mating rotation shaft 36 extending in the width direction of the scraper at the fourth end 332 of the loading portion 33. The connection end 40 of the limiting wall 4 may define a rotation hole 400 mated with the mating rotation shaft 36. The mating rotation shaft 36 may be inserted into the rotation hole 400, enabling the limiting wall 4 to rotate relative to the loading portion 33 about the mating rotation shaft 36. The mating rotation shaft 36 may be integrally formed with the loading portion 33 or may be installed on the loading portion 33 as an independent shaft. The rotation hole 400 may be a closed hole or an engagement hole with an opening to enable the limiting wall 4 to be assembled to the mating rotation shaft 36. When the loading portion 33 is at the in-use position, the free end 41 of the limiting wall 4 may be disposed near the third end 331 of the loading portion 33, such that the smaller first distance D1 may be formed between the free end 41 and the third end 331, such that the free end 41 and the loading portion 33 may cooperatively clamp or limit the blade 1 stably. When the loading portion 33 is at the replacement position, the limiting wall 4 may rotate about the mating rotation shaft 36 relative to the loading portion 33 to be opened, enabling the free end 41 to move away from the third end 331 of the loading portion 33, such that the second distance D2 greater than the first distance D1 may be formed. In this way, due to the rotatable connection between the limiting wall 4 and the second base body 3, opening and closing movement of the limiting wall 4 relative to the loading portion 33 may be achieved without significantly increasing overall structural complexity. The blade 1 may be stably loaded at the in-use position and may be easily inserted or removed at the replacement position.

As shown in FIGS. 14 to 16, in some embodiments, the engagement structure 35 may include the engagement protrusion 351 and the engagement groove 352. The scraper may further include at least one blade 1. The blade 1 may include the blade body 10 and the first engagement portion 121 and/or the second engagement portion 122 arranged on the blade body 10. The first engagement portion 121 may be engaged with the engagement groove 352, and the second engagement portion 122 may be engaged with the engagement protrusion 351.

Specifically, in the present embodiment, the engagement protrusion 351 and the engagement groove 352 may be engaged with blades 1 of various structural forms to improve the adaptability of the scraper to blades 1. The engagement protrusion 351 may be adapted with the blade 1 arranged with the second engagement portion 122 such as the hole, the groove, or the notch. The engagement groove 352 may be adapted with the blade 1 arranged with the first engagement portion 121 such as cladding or the protruding edge. Unlike the first embodiment, in the present embodiment, the limiting wall 4 may be connected to the second base body 3. When the limiting wall 4 is connected to the second base body 3 via rotatable connection, detachable connection, or any other connection manner that allows the limiting wall 4 to be opened relative to or separated from the loading portion 33, the engagement protrusion 351 and the engagement groove 352 may both be arranged on the limiting wall 4 or may be respectively arranged on the limiting wall 4 and the loading portion 33 as needed. The engagement protrusion 351 may not have to slide (as the loading portion 33 slides) to pass beyond the first end 201. Therefore, at the in-use position, the blade 1 may be stably loaded through the first distance D1; and at the replacement position, a larger loading/unloading space may be provided through the second distance D2 and the opening or separation of the limiting wall 4, such that insertion or removal of various blades 1 may be achieved. It should further be noted that, in order to achieve a more compact structure, a receiving groove 42 corresponding to the engagement protrusion 351 may be defined in the limiting wall 4, such that when the loading portion 33 is at the in-use position, the engagement protrusion 351 may be embedded in the receiving groove 42.

According to the scraper of the present disclosure, at the in-use position, the loading portion and the limiting wall may stably clamp or load the blade through the first distance; and at the replacement position, the loading portion and the limiting wall may provide a larger loading/unloading space through the second distance, such that blades of various specifications or structural forms may be easily loaded to or removed from the scraper. Therefore, adaptability of the scraper to various blades may be improved, and the blades may be replaced more conveniently, and user experience may be improved.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

What is claimed is:

1. A scraper, characterized by comprising:
a first base body, having a first end and a second end away from the first end, wherein the first base body comprises a limiting wall disposed at or near the first end; and
a second base body, comprising a connection portion and a loading portion, the connection portion is slidably connected with the first base body, wherein the loading portion and the limiting wall are configured to cooperatively load a blade; and the loading portion has a third end away from the connection portion and a fourth end near the connection portion;
wherein:
at least one of the loading portion and the limiting wall is arranged with an engagement structure; the engagement structure is capable of being mated with the blade to limit a relative position of the blade with respect to the loading portion and/or the limiting wall;
as the second base body slides, the loading portion is capable of reaching an in-use position and a replacement position;
when the loading portion is at the in-use position, a first distance is formed between the third end and the limiting wall in a thickness direction of the scraper; and
when the loading portion is at the replacement position, a second distance is formed between the third end and the limiting wall in the thickness direction of the scraper, and the second distance is greater than the first distance.

2. The scraper according to claim 1, wherein:
the engagement structure comprises an engagement protrusion and an engagement groove;
the engagement protrusion is arranged on the loading portion and near the third end; the engagement groove is defined in at least one of the loading portion and the limiting wall and is disposed closer to the fourth end than the engagement protrusion is;
when the loading portion is at the in-use position, both the engagement groove and the engagement protrusion are disposed between the first end and the second end, and the engagement protrusion is at least partially shielded by the limiting wall; and
when the loading portion is at the replacement position, the engagement protrusion is exposed out of the first base body through the first end.

3. The scraper according to claim 1, further comprising at least one blade, wherein the blade comprises a blade body and a cutting portion arranged on a side of the blade body; at least part of the blade body is disposed between the loading portion and the limiting wall, and at least part of the cutting portion extends beyond the third end.

4. The scraper according to claim 3, wherein:
the engagement structure comprises an engagement protrusion and an engagement groove;
the engagement protrusion is arranged on the loading portion and near the third end; the engagement groove is defined in at least one of the loading portion and the limiting wall and is disposed closer to the fourth end than the engagement protrusion is;
when the loading portion is at the in-use position, both the engagement groove and the engagement protrusion are disposed between the first end and the second end, and the engagement protrusion is at least partially shielded by the limiting wall;
when the loading portion is at the replacement position, the engagement protrusion is exposed out of the first base body through the first end; and
the blade further comprises an engagement portion, the engagement portion is capable of being mated with at least one of the engagement protrusion and the engagement groove, so as to limit a relative position of the blade with respect to the loading portion.

5. The scraper according to claim 4, wherein the engagement portion comprises a first engagement portion protruding from the blade body, and the first engagement portion is capable of being engaged in the engagement groove.

6. The scraper according to claim 5, wherein the first engagement portion is a cladding arranged on a side of the blade body away from the cutting portion.

7. The scraper according to claim 4, wherein the engagement portion comprises a second engagement portion recessed in the blade body, and the second engagement portion is capable of being mated with the engagement protrusion.

8. The scraper according to claim 4, wherein at least two engagement protrusions are arranged, the engagement portion comprises at least two second engagement portions recessed in the blade body; the at least two second engagement portions are capable of being mated with the at least two engagement protrusions in a one-to-one correspondence manner.

9. The scraper according to claim 4, wherein the engagement portion comprises a first engagement portion protruding from the blade body and a second engagement portion recessed in the blade body; the first engagement portion is capable of being mated in the engagement groove, and the second engagement portion is capable of being mated with the engagement protrusion.

10. The scraper according to claim 4, wherein the engagement portion comprises a first engagement portion protruding from the blade body; the first engagement portion is capable of being mated in the engagement groove; when the loading portion is at the replacement position, the second distance enables the first engagement portion to be capable of passing over the engagement protrusion to be received in or taken out of the engagement groove.

11. The scraper according to claim 1, wherein:
the first base body defines a limiting groove, the second base body is arranged with a limiting protrusion, and the limiting protrusion is slidable within the limiting groove;
the limiting groove comprises a limiting surface opposite to the limiting wall in the thickness direction; the limiting surface comprises a first limiting segment and a second limiting segment connected to the first limiting segment; the first limiting segment is disposed away from the first end, and the second limiting segment is disposed near the first end;
a distance between the first limiting segment and the limiting wall in the thickness direction is smaller than a distance between the second limiting segment and the limiting wall in the thickness direction; and
when the loading portion is at the in-use position, the limiting protrusion abuts against the first limiting segment; when the loading portion is at the replacement position, the limiting protrusion abuts against the second limiting segment, so as to enable the second distance to be greater than the first distance.

12. The scraper according to claim 11, wherein the limiting surface further comprises a guiding segment, the guiding segment is connected between the first limiting segment and the second limiting segment; the guiding segment is inclined relative to a sliding direction of the second base body so as to guide the limiting protrusion to slide and transit between the first limiting segment and the second limiting segment.

13. The scraper according to claim 1, wherein:
the first base body comprises a first wall and a second wall opposite to the first wall in a thickness direction thereof; an installation cavity is formed between the first wall and the second wall; and the limiting wall is formed on the first wall near the first end;
the first base body further comprises a guide hole defined in the first wall; the guide hole communicates the installation cavity with an outside of the first base body; the guide hole is elongated and extends along a sliding direction of the second base body; and
the connection portion comprises a connection body and a button arranged on the connection body; the connection body is slidably arranged in the installation cavity; at least part of the button passes through the guide hole and is exposed through the guide hole.

14. The scraper according to claim 13, wherein:
the first base body further comprises two side walls connected to the first wall and the second wall; and
the first base body further comprises an installation notch formed in the second wall; the installation notch is communicated with the installation cavity; an end of the installation notch near the first end penetrates the first end of the first base body, the button and the loading portion are misaligned with each other in the thickness direction; at least part of the loading portion is received in the installation notch; and the loading portion and the limiting wall cooperatively load the blade.

15. The scraper according to claim 14, wherein the first base body comprises at least one first limiting structure arranged on at least one of the two side walls; the second base body comprises at least one second limiting structure arranged on the loading portion; the at least one first limiting structure and the at least one second limiting structure are slidably mated with each other to limit the loading portion from disengaging from the installation notch in the thickness direction.

16. The scraper according to claim 15, wherein one of the at least one first limiting structure and the at least one second limiting structure is a limiting groove extending along the sliding direction, and the other one of the at least one first limiting structure and the at least one second limiting structure is a limiting protrusion.

17. The scraper according to claim 14, wherein the guide hole extends toward the first end, and a projection of the guide hole on a first projection plane and a projection of the installation notch on the first projection plane at least partially overlap with each other, the first projection plane is a plane perpendicular to the thickness direction.

18. A scraper, comprising:
a first base body, having a first end and a second end away from the first end;
a second base body, comprising a connection portion and a loading portion, the connection portion is slidably connected with the first base body, the loading portion has a third end away from the connection portion and a fourth end near the connection portion;
a limiting wall, having a connection end and a free end away from the connection end, wherein the connection end is connected to the second base body; and the loading portion and the limiting wall are configured to cooperatively load a blade;
wherein:
at least one of the loading portion and the limiting wall is arranged with an engagement structure; the engagement structure is capable of being mated with the blade to limit a relative position of the blade with respect to the loading portion and/or the limiting wall;
as the second base body slides, the loading portion is capable of reaching an in-use position and a replacement position;
when the loading portion is at the in-use position, in a sliding direction of the second base body, the connection end is disposed between the first end and the second end, and a first distance is formed between the third end and the free end in the thickness direction; and
when the loading portion is at the replacement position, in the sliding direction of the second base body, at least part of the connection end is disposed at a side of the first end away from the second end, a second distance is formed between the third end and the free end in the thickness direction; and the second distance is greater than the first distance.

19. The scraper according to claim 18, wherein the engagement structure comprises an engagement protrusion and an engagement groove; the scraper further comprises at least one blade; the blade comprises a blade body and at least one of a first engagement portion and a second engagement portion arranged on the blade body; the first engagement portion is capable of engaging with the engagement groove; and the second engagement portion is capable of engaging with the engagement protrusion.

20. The scraper according to claim 18, wherein the connection end of the limiting wall is rotatably connected to the second base body; when the loading portion is at the replacement position, the limiting wall is rotatable relative to the second base body to enable the second distance to be greater than the first distance.
